(19) United States
(12) Patent Application Publication
(10) Pub. No.: US 2026/0243121 A1
(43) Pub. Date: Aug. 20, 2026

(54) Simplified Hinge Structure

(71) Applicant: Jihuang Zhang, Dongguan (CN)

(72) Inventor: Jihuang Zhang, Dongguan (CN)

(21) Appl. No.: 19/537,996

(22) Filed: Feb. 12, 2026

(30) Foreign Application Priority Data
Feb. 18, 2025 (CN) 202520264521.1

(51) Int. Cl. E05D 11/10; E05D 3/02

(52) U.S. Cl. CPC E05D 11/1007; E05D 3/02

(57) ABSTRACT

Disclosed is a simplified hinge structure comprising: a central plate; a side-plate set of first and second side plates fixed together, their lower ends wrapping around opposite upper sides of the central plate to form a rotatable assembly; first and second detent grooves stamped inside-to-outside at the lower ends of the side plates, with outwardly drawn first and second protrusions at the outer lower ends; multiple first and second stepped teeth on the groove inner walls; and a detent pin assembly including a detent pin and a spring in the central plate. The detent pin projects laterally beyond the central plate, is received in the first and second detent grooves and blocked by the corresponding protrusions, and tooth grooves on the detent pin engage the teeth under spring force. The structure is simple, with few parts, low cost, easy installation, and high efficiency.

### CROSS-REFERENCE TO RELATED APPLICATIONS

The application claims priority of Chinese patent application 202520264521.1, filed on 02/18/2025, which is incorporated herein by reference in its entirety.

### TECHNICAL FIELD

The present disclosure relates to the field of hinge technologies and, more particularly, to a simplified hinge structure.

### BACKGROUND

Chinese patent application No. 202021024450.1 discloses a “fine-tooth hinge” including: a rotary gear fixed to an insertion rod; a side-plate set having first and second side plates rotatably mounted on opposite sides of the rotary gear, each plate being provided with corresponding first and second mounting holes; a detent toothed block passing through the mounting holes, the block having first fine helical teeth at its upper end meshing with second fine helical teeth of the rotary gear; first and second spring pieces respectively located in the mounting holes and abutting both sides of a lower end surface of the detent block; a fixed support plate installed between the side plates beside the lower end surface of the detent block; and a cover-plate set including first and second cover plates respectively fixed to the outer sides of the first and second side plates to cover their mounting holes.

In that design, the mounting holes extend through the side plates. After the detent block is installed, outer cover plates must be added on both side plates to retain the block and prevent it from coming out. This increases the part count, introduces additional tooling/manufacturing cost for the new parts, and adds assembly steps, reducing convenience and efficiency.

The present disclosure addresses the foregoing issues.

### SUMMARY

The objective of the present disclosure is to overcome deficiencies of the prior art and to provide a simplified hinge structure.

To address the above technical problems, the present disclosure adopts the following technical solution: A simplified hinge structure includes a central plate and a side-plate set that includes a first side plate and a second side plate fixed together at their upper ends, the lower ends being wrapped around opposite upper sides of the central plate to form a rotatable assembly. The lower ends of the first and second side plates are stamped from inside to outside to form a first detent groove and a second detent groove, and the outer lower ends of the first and second side plates are drawn to form outwardly projecting first and second protrusions corresponding to the first and second detent grooves. Inner walls of the first and second detent grooves are formed with multiple first and second protruding teeth arranged in a stepped pattern. A detent pin assembly includes a detent pin piece extending through and movable in the central plate and a spring piece that abuts the detent pin piece to provide elastic force. Opposite sides of the detent pin piece extend outward beyond the two side faces of the central plate and are respectively embedded in the first and second detent grooves and blocked by the first and second protrusions. Tooth grooves on the detent pin piece bear against and engage the first and second protruding teeth under the elastic force of the spring piece.

Further, in the above technical solution, the detent pin piece is plate shaped. Tooth grooves are formed on an upper side of its end by a half-shear stamping process, and a third protrusion is formed on a lower side of that end at a position corresponding to the tooth grooves. An end of the spring piece abuts a rear side of the third protrusion.

Further, in the above technical solution, the lower ends of the first side plate and the second side plate are bent to form a first pivot portion and a second pivot portion. The first pivot portion and the second pivot portion are wrapped around opposite upper sides of the central plate and are mounted by a pivot pin to form the rotatable assembly.

Further, in the above technical solution, a first bend portion is formed between the lower end of the first side plate and the first pivot portion, and a first hole for reducing stress is punched in the first bend portion. A second bend portion is formed between the lower end of the second side plate and the second pivot portion, and a second hole for reducing stress is punched in the second bend portion.

Further, in the above technical solution, the upper end of the central plate has a central hole through which the pivot pin passes. Outside the central hole, a first receiving hole for accommodating the spring piece and a first movement hole in communication with the first receiving hole are provided. The detent pin piece passes through the first movement hole and can move within it. The spring piece is positioned in the first receiving hole, and an end of the spring piece extends into the first movement hole and abuts a rear side of the third protrusion.

Further, in the above technical solution, the spring piece includes a C shaped base and a spring arm integrally formed on the base. The base is embedded and positioned in the first receiving hole. An end of the spring arm passes through the first receiving hole and extends into the first movement hole to abut the rear side of the third protrusion.

Further, in the above technical solution, the number of detent pin assemblies is two, arranged in rotational symmetry. An angle between adjacent tooth grooves is from 1 to 20 degrees.

Further, in the above technical solution, the number of central plates is two, which are fitted together and fastened to each other.

Further, in the above technical solution, the two central plates have the same shape and structure, and multiple first positioning holes are provided on the central plate.

Further, in the above technical solution, the first side plate and the second side plate have the same shape and structure and are installed as mirror images of each other. The first side plate and the second side plate respectively have corresponding second positioning holes and third positioning holes.

After adoption of the above technical solution, the present disclosure has the following beneficial effects compared with the prior art:

At the lower ends of the first side plate and the second side plate, a first detent groove and a second detent groove are formed by stamping from inside to outside, and outwardly projecting first and second protrusions corresponding to the grooves are formed by drawing on the outer lower ends. The first and second protrusions block the detent pin piece received in the first and second detent grooves so as to restrict the detent pin piece and prevent it from coming out, thereby eliminating the need to add cover plates on the outer sides of the first side plate and the second side plate, reducing the number of parts, saving cover plate tooling and manufacturing cost, and reducing assembly steps. Assembly is more convenient and efficient, and after the first and second protrusions are formed by drawing on the first and second side plates, their strength is higher, structural stability is improved, and service life is longer.

The detent pin piece is plate shaped. Tooth grooves are formed on an upper side of its end by a half-shear stamping process, and a third protrusion is formed on a lower side at a position corresponding to the tooth grooves. This increases the strength of the detent pin piece and reduces production cost.

### BRIEF DESCRIPTION OF THE DRAWINGS

FIG. 1 is a perspective view of the simplified hinge structure;

FIG. 2 is another perspective view of the simplified hinge structure;

FIG. 3 is an exploded view of the simplified hinge structure;

FIG. 4 is a sectional view of the simplified hinge structure;

FIG. 5 is an assembly view showing the first side plate, the central plate, and the detent pin assembly;

FIG. 6 is an assembly view showing the first side plate and the detent pin assembly;

FIG. 7 is a perspective view of the second side plate.

### DETAILED DESCRIPTION OF EMBODIMENTS

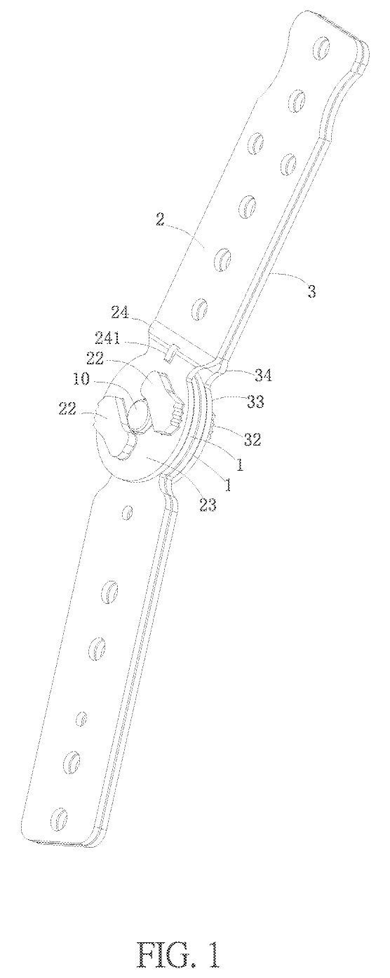

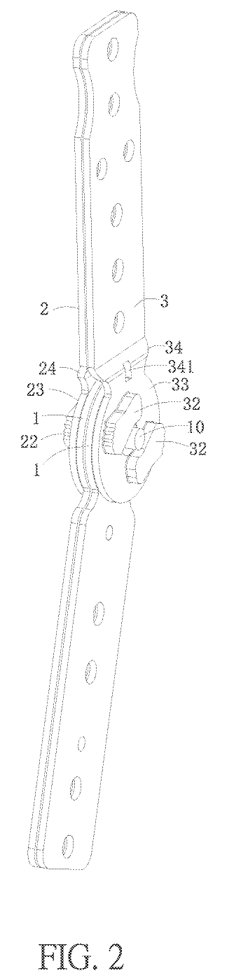

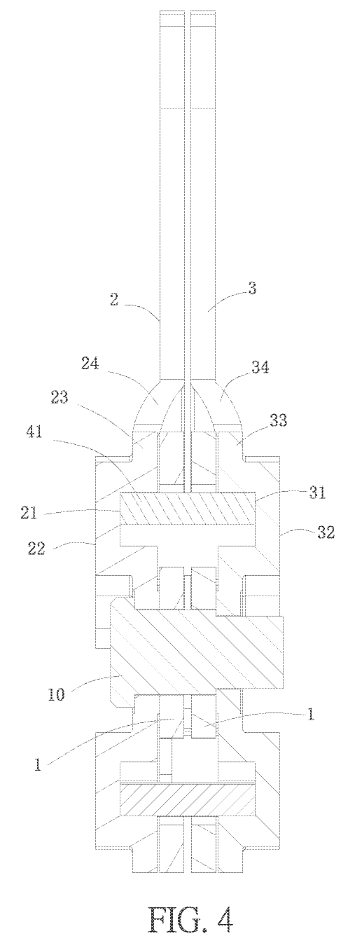

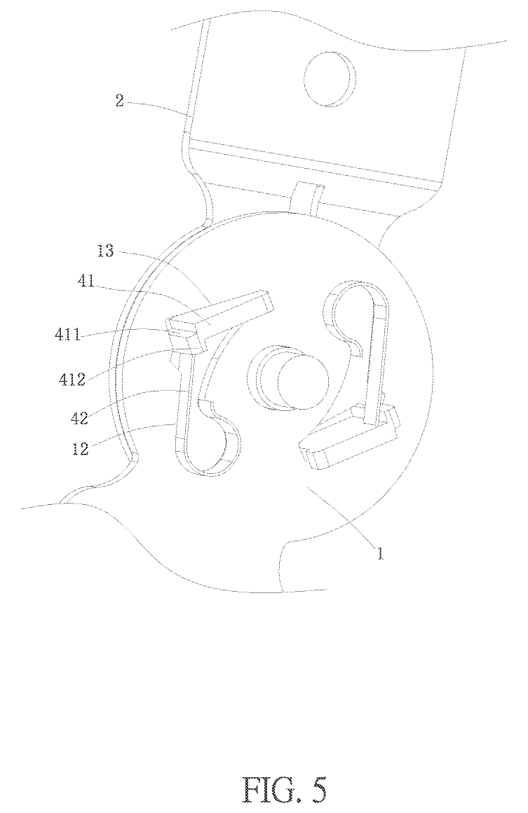

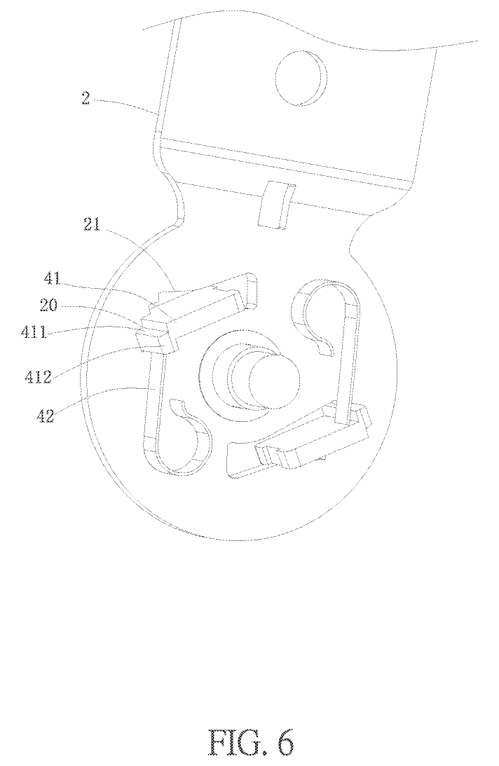

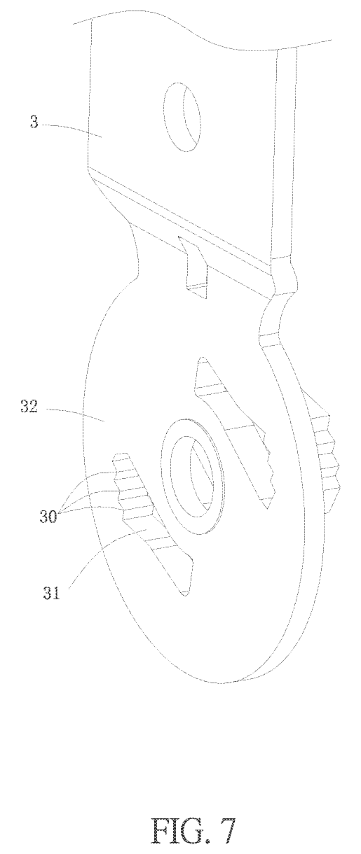

With reference to FIGS. 1–7, a simplified hinge structure comprises a central plate (1), a side-plate set rotatably connected to the central plate (1), and detent pin assemblies (4) installed between the central plate (1) and the side-plate set.

The side-plate set includes a first side plate (2) and a second side plate (3) fixed together at their upper ends. Their lower ends wrap around opposite upper sides of the central plate (1) to form a rotatable assembly. The lower ends of the first and second side plates (2, 3) are, from inside toward outside, stamped to form a first detent groove (21) and a second detent groove (31), respectively. The angle between adjacent tooth grooves (411) of the detent pin piece is 1° to 20°. The outer lower ends of the first and second side plates (2, 3) are drawn to form outward retaining protrusions (22, 32) corresponding to the first and second detent grooves (21, 31). Inner walls of the first and second detent grooves (21, 31) are formed with multiple stepped protruding teeth (20, 30).

Each detent pin assembly (4) includes a detent pin piece (41) that passes through and can move within the central plate (1), and a spring piece (42) that biases the detent pin piece (41). Opposite ends of the detent pin piece (41) extend beyond the two side faces of the central plate (1) and are embedded in the first and second detent grooves (21, 31), where they are retained by the protrusions (22, 32). The tooth grooves (411) on the detent pin piece (41) engage the protruding teeth (20, 30) under the elastic force of the spring piece (42), thereby providing detented positioning.

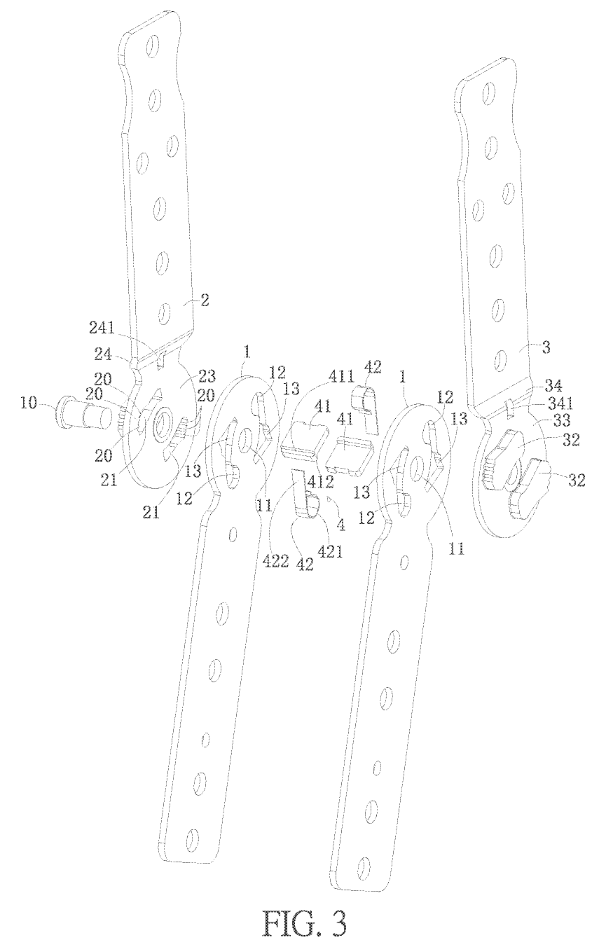

In use (see FIG. 3), when the side-plate set is held stationary (e.g., fixed to a mounting base), the tooth grooves (411) of the detent pin piece (41) engage the protruding teeth (20, 30) under the force of the spring piece (42) to prevent rearward (clockwise) rotation of the central plate (1) relative to the side-plate set, while permitting forward (counterclockwise) rotation to the next detent. Thus, the angular position between the side-plate set and the central plate (1) is adjustable in increments of 1° to 20°. The minimum angle corresponds to engagement of the tooth grooves (411) with the lowest protruding teeth (20, 30), and the maximum angle corresponds to engagement with the uppermost protruding teeth (20, 30).

The detent pin piece (41) is plate-shaped. Tooth grooves (411) are formed on an upper side of its end by a half-shear stamping operation. A third projection (412) is formed on a lower side of the same end at a position corresponding to the tooth grooves (411). An end of the spring piece (42) bears against a rear side of the third projection (412).

The lower ends of the first and second side plates (2, 3) are bent to form pivot portions (23, 33) that wrap around opposite upper sides of the central plate (1). A pivot pin (10) extends through to provide the rotatable mounting.

Between the lower end of the first side plate (2) and its pivot portion (23), a first bend portion (24) is formed to increase strength. A first stress-relief hole (241) is punched in the first bend portion (24). Similarly, between the lower end of the second side plate (3) and its pivot portion (33), a second bend portion (34) is formed with a second stress-relief hole (341).

An upper end of the central plate (1) includes a central hole (11) for the pivot pin (10). Outside the central hole (11), a receiving recess (12) for housing the spring piece (42) and a movement slot (13) communicating with the receiving recess (12) are formed. The detent pin piece (41) passes through and moves within the movement slot (13). The spring piece (42) is positioned in the receiving recess (12), with its end extending into the movement slot (13) to bear against the rear side of the third projection (412). This arrangement increases the strength of the detent pin piece and reduces manufacturing cost.

The spring piece (42) includes a C-shaped base (421) integrally formed with a spring arm (422). The base (421) is embedded and positioned in the receiving recess (12). The end of the spring arm (422) extends through the receiving recess (12) into the movement slot (13) to bear against the rear side of the third projection (412), thereby providing stable elastic force to the detent pin piece.

In certain embodiments, two detent pin assemblies (4) are provided in rotational symmetry, ensuring stable positioning between the central plate (1) and the detent pin assemblies (4).

In certain embodiments, the central plate (1) is formed by two plates fitted together and fastened to one another for improved structural stability, longer service life, and enhanced support capacity. The two central plates have the same shape and structure and include multiple first positioning holes (14).

The first side plate (2) and second side plate (3) have the same shape and structure and are installed in mirror symmetry. They include corresponding second positioning holes (25) and third positioning holes (35), respectively.

As described above, forming the internal detent grooves (21, 31) and the outward retaining protrusions (22, 32) at the lower ends of the side plates (2, 3) eliminates external cover plates, thereby reducing part count, tooling and manufacturing cost, and assembly steps, while improving strength, stability, and service life.

1. A simplified hinge structure, comprising:
a central plate (1);
a side-plate set including a first side plate (2) and a second side plate (3) whose upper ends are fixed together, lower ends of the first side plate (2) and the second side plate (3) wrapping around opposite upper sides of the central plate (1) to form a rotatable assembly; wherein the lower ends of the first side plate (2) and the second side plate (3) are stamped from inside to outside to form a first detent groove (21) and a second detent groove (31), and outer lower ends of the first side plate (2) and the second side plate (3) are drawn to form outwardly projecting first and second protrusions (22, 32) respectively corresponding to the first detent groove (21) and the second detent groove (31); inner walls of the first detent groove (21) and the second detent groove (31) are formed with multiple first protruding teeth (20) and second protruding teeth (30) arranged in a stepped pattern; and
a detent pin assembly (4) including a detent pin piece (41) extending through and movable within the central plate (1) and a spring piece (42) abutting the detent pin piece (41) to provide elastic force, opposite sides of the detent pin piece (41) extending beyond two side faces of the central plate (1) and being respectively embedded in the first detent groove (21) and the second detent groove (31) and blocked by the first protrusion (22) and the second protrusion (32), and tooth grooves (411) on the detent pin piece (41), under the elastic force of the spring piece (42), being in close engagement with the first protruding teeth (20) and the second protruding teeth (30).

2. The simplified hinge structure of claim 1, wherein the detent pin piece (41) is plate-shaped, the tooth grooves (411) are formed on an upper side of an end of the detent pin piece (41) by a half-shear stamping process, a third protrusion (412) is formed on a lower side of the end of the detent pin piece (41) at a position corresponding to the tooth grooves (411), and an end of the spring piece (42) abuts a rear side of the third protrusion (412).

3. The simplified hinge structure of claim 1, wherein the lower ends of the first side plate (2) and the second side plate (3) are bent to form a first pivot portion (23) and a second pivot portion (33), the first pivot portion (23) and the second pivot portion (33) wrap around the opposite upper sides of the central plate (1), and are mounted by a pivot pin (10) to form the rotatable assembly.

4. The simplified hinge structure of claim 3, wherein a first bend portion (24) is formed between the lower end of the first side plate (2) and the first pivot portion (23), the first bend portion (24) being punched to form a first stress-relief hole (241); and a second bend portion (34) is formed between the lower end of the second side plate (3) and the second pivot portion (33), the second bend portion (34) being punched to form a second stress-relief hole (341).

5. The simplified hinge structure according to claim 1, wherein an upper end of the central plate (1) has a central hole (11) through which a pivot pin (10) passes, and outside the central hole (11) the upper end of the central plate (1) is provided with a first receiving hole (12) for accommodating the spring piece (42) and a first movement hole (13) in communication with the first receiving hole (12), the detent pin piece (41) extends through and is movable within the first movement hole (13), the spring piece (42) is positioned in the first receiving hole (12), and an end of the spring piece (42) extends into the first movement hole (13) to abut a rear side of a third protrusion (412).

6. The simplified hinge structure of claim 5, wherein the spring piece (42) includes a C-shaped base (421) and a spring arm (422) integrally formed on the base (421), the base (421) being embedded and positioned in the first receiving hole (12), and an end of the spring arm (422) passing through the first receiving hole (12) to extend into the first movement hole (13) and abut the rear side of the third protrusion (412).

7. The simplified hinge structure of claim 6, wherein two detent pin assemblies (4) are provided in rotational symmetry, and an angle between adjacent tooth grooves (411) is from 1 to 20 degrees.

8. The simplified hinge structure of claim 7, wherein a number of central plates (1) is two, which are fitted together and fastened to each other.

9. The simplified hinge structure of claim 8, wherein the two central plates (1) are of the same shape and structure, and each of the two central plates (1) has multiple first positioning holes (14).

10. The simplified hinge structure according to claim 1, wherein the first side plate (2) and the second side plate (3) are of the same shape and structure and are installed as mirror images of each other, and the first side plate (2) and the second side plate (3) respectively have corresponding second positioning holes (25) and third positioning holes (35).
